(19) United States
(12) Patent Application Publication
(10) Pub. No.: US 2002/0160178 A1
(43) Pub. Date: Oct. 31, 2002

(54) Intumescent arrangement and an associated method of protecting construction materials from the effects of heat and fire

(76) Inventors: Dan French, Silver Lake, IN (US); Tony Scott, Carmel, IN (US)

Correspondence Address: BARNES & THORNBURG, 11 SOUTH MERIDIAN, INDIANAPOLIS, IN, 46204

(21) Appl. No.: 10/090,716

(22) Filed: Mar. 4, 2002

Related U.S. Application Data
(60) Provisional application No. 60/273,358, filed on Mar. 5, 2001.

(51) Int. Cl. B32B 9/00; B32B 3/06; B32B 27/00; B32B 5/02; B05D 5/00; B32B 27/24

(52) U.S. Cl. 428/319.3; 428/318.4; 428/306.6; 427/243; 442/138

(57) ABSTRACT

An intumescent arrangement and an associated method of protecting construction materials from the effects of heat and fire is disclosed.

### BACKGROUND OF THE INVENTION

The present invention generally relates to the protection of various construction materials from the effects of heat and fire. The present invention particularly relates to an intumescent arrangement and an associated method of protecting construction materials from the effects of heat and fire.

Every type of building, including businesses, residences, public and government facilities are, without exception, vulnerable to fire. Death, injury, and destruction from fire effect every country and every level of social strata. For example, in the United States alone, fires strike nearly two million times annually and cause an estimated $10 billion in property damage. More, tragically, fires also cause nearly 4000 deaths each year, and injure nearly 22,000 men, women, and children.

Various strategies have been developed in an attempt to address the above described problems, including the development of materials which possess heat-insulating or fire-retarding characteristics. It is generally accepted that there are three major categories of materials which possess heat-insulating or fire-retarding characteristics. The first group of fire-retarding materials include porous or fibrous materials which exhibit low heat conductivity due primarily to the presence of air trapped in the pores or among the fibers of a fibrous batting. Typically, the heat conductivity of these materials is not altered by fire or by high temperature, and the heat transfer through the material as a function of time can be represented by a straight line up to the point of melting. However, most of these materials melt at a temperature of about 1500° to 1800° C. and thus are limited in their usage and degree of protection.

A second group of fire-retarding materials include the ablative materials. These are materials that go through thermal, chemical and/or mechanical degradation in a manner that absorbs or dissipates energy. These materials do find some use in specialized applications because of their ability to withstand high temperatures, as well as their significant resistance to heat transfer, but their use in the residential sector is somewhat limited for various reasons.

A third group of fire-retarding materials is the intumescent materials. The characteristic feature of all intumescent materials is that the intumescent composition, upon exposure to heat or flame, swells or puffs up to a relatively thick cellular foam char which possesses heat-insulative and fire-retardant properties. In particular, the heat or flame activated reaction causes the intumescent materials to foam and expand into a thick cellular foam char and generate inert gases such as nitrogen, carbon dioxide, etc., which are entrapped in the foam and thus prevent the access of air and oxygen to the combustible substrate. This swelled cellular, generally carbonaceous, char layer which adheres to the substrate expands to many times the thickness of the original coating and thus effectively insulates the substrate from heat and serves as an effective oxygen barrier.

However, some intumescent materials also suffer from various drawbacks. For example, some intumescent materials contain toxic and potentially carcinogenic compounds. Others are based on fire resistant chemicals suspended in water, as a result, they do not bond well to the surfaces of various construction materials, e.g. polyurethane spray foam insulation. The water matrix also causes the char barrier to rise too far off the substrate, thereby resulting in the fragile char barrier being easily compromised. Once compromised, fire can easily undermine the rest of the intumescent layer rendering it useless. Still others are unacceptable as a result of their unpleasant odor, lumpy texture, and their inability to go through a paint sprayer without clogging the nozzle.

Therefore, in light of the above discussion, it is apparent that an intumescent arrangement and an associated method of protecting construction materials from the effects of heat and fire, which addresses one or more of the above discussed drawbacks is desirable.

### SUMMARY OF THE INVENTION

In accordance with one embodiment of the present invention, there is provided an intumescent arrangement. The intumescent arrangement includes (i) an insulation foam having a surface and (ii) an intumescent substance disposed on the surface of the insulation.

Pursuant to another embodiment of the present invention, there is provided a method of protecting a construction material. The method includes disposing an intumescent substance upon a surface of an insulation foam.

According to yet another embodiment of the present invention, there is provided an intumescent arrangement. The intumescent arrangement includes (i) a door having a surface and (ii) an intumescent substance disposed on the surface of the door.

According to still another embodiment of the present invention, there is provided a method of protecting a construction material. The method includes disposing an intumescent substance upon a surface of a door.

Pursuant to still another embodiment of the present invention, there is provided an intumescent arrangement. The intumescent arrangement includes an insulation foam which includes polyurethane foam. The intumescent arrangement also includes an intumescent substance disposed on a surface of the insulation foam.

It is therefore an object of the present invention to provide a new and useful intumescent arrangement.

It is another object of the present invention to provide an improved intumescent arrangement.

It is yet another object of the present invention to provide a new and useful method of protecting construction materials from the effects of heat and fire.

It still another object of the present invention to provide an improved method of protecting construction materials from the effects of heat and fire.

The above and other objects, features, and advantages of the present invention will become apparent from the following description and attached drawings.

### BRIEF DESCRIPTION OF THE DRAWINGS

FIG. 1 is a fragmentary view of a construction material with a portion thereof having an intumescent substance disposed thereon.

### DETAILED DESCRIPTION OF THE PREFERRED EMBODIMENT

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

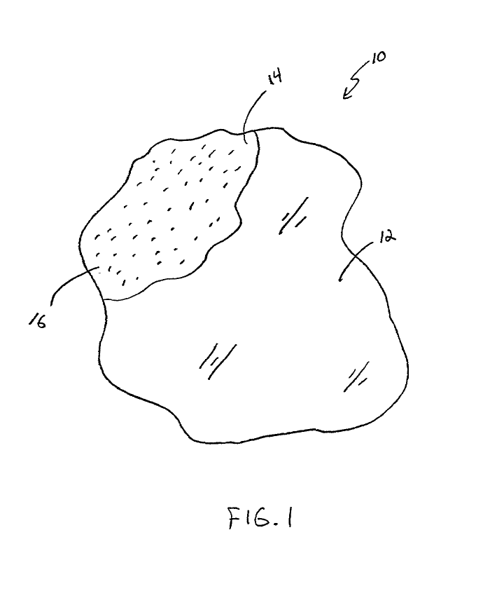

Referring now to FIG. 1, there is shown a fragmentary view of a construction material 10 having a surface 12. Disposed on a portion 14 of surface 12 of construction material 10 is an intumescent substance 16. Note that only a portion of surface 12 has intumescent substance 16 disposed thereon for clarity of description. However, it is contemplated that entire surface 12, or only a portion thereof as shown in FIG. 1, can have intumescent substance 16 disposed thereon. Intumescent substance 16 is applied to surface 12 in any appropriate manner for the specific construction material 10 being protected. For example, methods of applying intumescent substance 16 onto surface 12 include, but are not limited to, painting with a brush, painting with a roller, or spraying with a paint sprayer.

It should be appreciated that having intumescent substance 16 disposed on construction material 10 protects construction material 16 from the effects of heat and fire as discussed above. In particular, while not being limited to the particular mechanism, intumescent substance 16, upon exposure to heat or flame, swells or puffs up to a relatively thick cellular foam char which possesses heat-insulative and fire-retardant properties. Specifically, the heat or flame activated reaction causes intumescent substance 16 to foam and expand into a thick cellular foam char and generate inert gases such as nitrogen, carbon dioxide, etc., which are entrapped in the foam and thus prevent the access of air and oxygen to construction material 10. This char layer which adheres to surface 12 expands to many times the thickness of the original coating and thus effectively insulates construction material 10 from heat and serves as an effective oxygen barrier, thereby protecting construction material 10 from combustion.

It should be appreciated that construction material 10 can be any material utilized in the construction of structures which has a surface upon which intumescent substance 16 can be disposed. For example, construction materials 10 which can be protected utilizing the present invention include, but are not limited to, wood structures, metal structures, insulation materials, plastic materials, fabric made from synthetic or natural fibers, and sheet rock or dry wall. Specific examples of construction articles which can be protected utilizing the present invention include, but are not limited to, doors, walls, and insulation foam such as polyurethane foam.

With respect to polyurethane foam it should be appreciated that this spray foam insulation is widely used in the construction industry and continues to grow in popularity. Although an effective form of thermal and sound insulation, polyurethane spray foam insulation is highly flammable. Furthermore, because most polyurethane based insulation products include polymeric isocyanate, the smoke produced when these products burn is toxic. As previously mentioned, disposing intumescent substance 16 upon the surface of a polyurethane spray foam insulation product protects the product from the effects of heat and fire and thus converts the polyurethane spray foam insulation product from a fire hazard, capable of releasing toxic smoke, to an effective fire barrier. With respect to doors, it should be understood that disposing intumescent substance 16 upon the surface of a wood and/or composite door converts an ordinary door into an effective fire barrier.

For example, one insulating polyurethane foam which can be protected utilizing the present invention is described in U.S. Pat. No. 5,169,872, which is incorporated herein by reference. In particular, U.S. Pat. No. 5,169,872 describes a process of preparing a rigid polyurethane and polyisocyanurate foam. The method includes: (1) mixing a formulation comprising: (i) at least one reactive diisocyanate; (ii) at least one reactive polyol; (iii) at least one catalyst; (iv) an organic blowing agent; (v) water, and (vi) a polyurethane foam additive having the following general formula

(CH₃)₃SiO{SiO(CH₃)₂}x{SiO(CH₃)R}_{y}Si(CH₃)₃

wherein R is —(CₙH₂ₙO(CH₂CH₂O)_{w}{CH₂(CH₃)—CHO}_{z} R′, wherein R′ is selected from a group consisting of —(C═O)R″, hydrogen, alkyl radicals having 1 to 6 carbon atoms, and —R″, wherein R″ is selected from a group consisting of alkyl radicals having from 1 to 6 carbon atoms, n has a value of 3 to 6, x has a value of 27 to 33, y has a value of 3 to 5, z has a value of 0 or 1, and w has a value of 6 to 100, wherein the ratio of x to y is in the range of 5 to 12:1 and the amount of organic blowing agent (iv) does not exceed the amount of water (v) in the incipit mixture; (2) allowing the incipit mixture to react and cure whereby a rigid polyurethane and polyisocyanurate foam is obtained.

However, it should be understood that other insulating polyurethane foams can be protected utilizing the present invention, and the present invention is not limited to protecting the insulating polyurethane foams specifically described in the aforementioned patent.

An intumescent material 16 which can be utilized in the present invention is described in U.S. Pat. No. 4,198,328 which is incorporated herein by reference. In particular, the flame-resisting paints according to the aforementioned United States Patent consist of the following essential components, besides other possible additives normally used in the techniques of the field: (1) from 10 to 20 parts of a solvent normally used as paint diluent, such as, for example, benzene, toluene, xylenes, chlorinated aliphatic hydrocarbons, esters, alcohols, oil of turpentine, white spirit and water; (2) from 30 to 60 parts of a binder or base of a polymeric nature such, for example, as polyurethane resins, phenolic resins, ureic resins, epoxy resins, alkyd resins, acrylic resins, vinyl resins, polybutadiene, polyisoprene, polychloroprene, polyisobutylene, butadiene-acrylonitrile or butadiene-styrene copolymers, random propylene-ethylene copolymers and still others; (3) from 15 to 3.5 parts of an ammonium or amine phosphate; and (4) from 7 to 18 parts of one or more water-insoluble nitrogen containing compounds chosen from among: (a) the reaction products of an aldehyde with compounds containing two —NR— groups or an —NR— group and a —CO— and/or —CS— group inserted in a cyclic structure (R═H or hydroxyalkyl with from 1 to 4 carbon atoms), and (b) the reaction products of aliphatic or aromatic diisocyanates or triisocyanates with organic compounds having in the molecule reactive hydrogen atoms. Among the various usable phosphates, those preferred for their easy availability are the ammonium polyphosphates falling within the general formula (NH₄)ₙ+₂PₙO₃ₙ+₁, wherein n represents a whole number equal to or greater than 2; preferably the molecular weight of the polyphosphates must be sufficiently high to ensure a low solubility in water. The composition of the polyphosphates having the above indicated formula, in which n is a number sufficiently great, is practically that which corresponds to the formula of the metaphosphates (NH₄PO₃)ₙ. An example of such polyphosphates is the one known under the trademark “Exolit 263” (produced and marketed by the firm Benckiser Knapsack GmbH) and having the composition (NH₄PO₃)ₙ wherein n is greater than 50; another example is the product known under the trademark “Phos-Chek P/30” (produced and marketed by Monsanto Chemical Co.) and having an analogous composition. Other usable phosphates are those derived from amines, such as for instance dimethylammonium or diethylammonium phosphate, ethylendiamine phosphate, ortho- or pyrophosphate of melamine.

An example of melamine phosphate is that which is obtained by treating an aqueous melamine solution heated at 70°-90° C. with H₃PO₄ and then separating the precipitate that thus forms the two reactants being used in a molar ratio H₃PO₄/melamine, of about 3:2. Examples of compounds to be used in the form of reaction products with the aldehydes are: ethylene-urea, ethylene-thiourea, hydantoin, hexahydropyrimi-din-Zone, piperazine-3,6-dione, barbituric acid, uric acid, piperazine, 1,4-bis(2-hydroxypropyl)piperazine, tris(Zhydroxyethy1) isocyanurate. The preferred aldehyde is formaldehyde.

Other compounds having reactive hydrogen atoms, besides those mentioned above, include: ethylenediamine, tetramethylene diamine, phenylene diamines, toluylene diamines, xylylene diamines, melamine, and polyvalent alcohols such as: ethyleneglycol, diethyleneglycol, triethyleneg-lycol, glycerol, trimethylol ethane, trimethylol pro-pane, pentaerythritol, dipentaerythritol, tripentaerythri-tol, 1,2,4-butane triol, 1,2,6-hexane triol, and the like.

Other organic isocyanates usable in the reaction with the compounds having reactive hydrogen atoms, include: hexamethylene diisocyanate, 24 and 2,6-toluylene diisocyanate, o-, m- and p-phenylene diisocynate, diphenyl methane 4,4′-diisocyanate, dianisidine diisocyanate, tolidine diisocyanate and tri-phenylmethane triisocyanate. The reaction products of the aldehydes with the cyclic nitrogen containing compounds are prepared according to known methods: an aqueous solution of the nitrogen containing compound, acidified with H2SO4 (pH═2-3), is made to react at between 80° and 100° C. under stirring, with an aqueous, 37% by weight/volume formaldehyde solution that is added dropwise at a ratio of 1-1.5 mols per functional group present in the nitrogen containing compound. The reaction may use a glass flask provided with a dripping funnel, a stirrer and a reflux cooler. The polycondensate obtained precipitates in the form of a finely subdivided powder which is then filtered, washed and dried.

The reaction products of the organic isocyanates with the compounds having reactive hydrogen atoms, are prepared by introducing the two reactants into the flask of a rotary evaporator, and heating the suspension thus obtained at a temperature comprised between 100° C. and 180° C., for a time varying between 1 and 3 hours, depending on the temperature chosen: if this latter is, for instance, 150° C., a 2 hour heating will suffice. The reaction between the two compounds develops practically stoichiometrically in as much as each functional group of one of the reactants reacts with one functional group of the other reactant; it follows that the molar ratio between the two reactants will depend on the number of functional group present in each of the reactants. Thus, for instance, a diisocyanate will be made to react with pentaerythritol in a molar ratio of 2: 1, while it will be made to react with ethylene diamine in a molar ratio of 1:1. At the end of the reaction there will be obtained a solid product that is washed with acetone, then with water and then again with acetone in order to remove the unreacted compounds. The intumescent paints according to U.S. Pat. No. 4,198,328 are prepared according to any one of the known techniques for mixing the components.

The anti-flame properties of the paints which are the object of U.S. Pat. No. 4,198,328 are practically independent from the nature of the polymer used as binder which may thus be any one of the polymers normally used as bases for paints. In addition they are characterized, besides by excellent anti-flame properties at thickness of films lower than those of the “Prior Art”, also by a low development of smokes in case of fire and by a great resistance to water and to atmospheric agents (moisture, salty mist, thermal cycles); they may also be used in the field of washable surfaces without any loss in the course of time of their flame-resistance characteristics and can be applied according to all known methods, such as for instance: brushing, spraying, dipping or roller spreading.

However, it should be understood that other intumescent materials can be utilized in the present invention, and thus the present invention is not limited to the intumescent materials specifically described in the aforementioned patent.

While the invention has been illustrated and described in detail in the drawings and foregoing description, such illustration and description is to be considered as exemplary and not restrictive in character, it being understood that only the preferred embodiments have been shown and described and that all changes and modifications that come within the spirit of the invention are desired to be protected.

What is claimed is:

1. An intumescent arrangement, comprising:
an insulation foam having a surface; and
an intumescent substance disposed on said surface of said insulation foam.

2. A method of protecting a construction material, comprising:
(a) disposing an intumescent substance upon a surface of an insulation foam.

3. An intumescent arrangement, comprising:
a door having a surface; and
an intumescent substance disposed on said surface of said door.

4. A method of protecting a construction material, comprising:
(a) disposing an intumescent substance upon a surface of a door.

5. An intumescent arrangement, comprising:
an insulation foam which includes polyurethane foam, said insulation foam having a surface; and
an intumescent substance disposed on said surface of said insulation foam.
